(19) United States
(12) Patent Application Publication
(10) Pub. No.: US 2002/0080772 A1
(43) Pub. Date: Jun. 27, 2002

(54) Method and device for communication through the internet

(76) Inventor: Claes Magnusson, Lund (SE)

Correspondence Address: John R. Ley, Esq., JOHN R. LEY, LLC, Suite 610, 5299 DTC Boulevard, Englewood, CO, 80111-3327, US

(21) Appl. No.: 09/748,332

(22) Filed: Dec. 21, 2000

(51) Int. Cl. H04L 12/66

(52) U.S. Cl. 370/352; 370/401; 370/329

(57) ABSTRACT

A method for communication over a network, such as the Internet, including the steps of retrieving at least audio signals, digitising the signals into digital signals, transferring the digital signals to broadcasting means and making the digital signals accessible over a network, such as the Internet. The method includes the steps of retrieving at least audio signal in a mobile telecommunication device, and transferring at least audio signals from the mobile telecommunication device to a corresponding receiving telecommunication device over a wireless connection

A mobile telecommunication device is used for retrieving at least audio signals and the mobile telecommunication device is connected in a wireless connection to the corresponding receiving telecommunication device. The receiving telecommunication device is operatively connected to a to a combined digitising, packaging and broadcasting device that is connected to the Internet.

### TECHNICAL FIELD

The invention relates to a method for communication over a network, such as the Internet, and also to a device for providing the communication.

It has become very popular to send audio and video data over the Internet. Either “fixed” material, such as in advance prepared movies, is made available on-demand or audio and/or video is broadcasted live. It is thus possible to follow a local event from any location in the world that has an access to the Internet.

### PRIOR ART

In a prior art system an event such as a press conference is made available to the public over the Internet by the use of local hardware. Microphones and television cameras are connected to a local digitising and encoding computer, normally supervised by at least one person.

The digitising and encoding computer is connected to the Internet through a high capacity connection, for instance a high speed ISDN connection. It is normally possible to acquire such a connection on a temporary basis at a considerable cost. The digitising and encoding computer is connected to a broadcasting computer through the Internet. It is the broadcasting computer that supplies the information to any user that is connected to the Internet and that has accessed the broadcasting computer with suitable software.

In prior art systems it is a drawback that local hardware and connectivity such as an ISDN connection has to be provided in advance. There are problems to arrange an event at a short notice. Furthermore, the costs for the necessary hardware are considerable.

### SUMMARY OF THE INVENTION

An object of the present invention is to overcome the drawback and problem mentioned above. In accordance with the invention a wireless device is used to pick up audio and/or video signals from an event. The signals are transferred to a receiver that is connected to a remote digitising, encoding and broadcasting device. The encoded signals are then made available through the Internet in a conventional manner. Any user located at any place may then access the signals by the use of the proper and conventional software.

In one embodiment a conventional cellular telephone is used as the pick up device. A similar cellular telephone can be used also as receiver. The receiver is put in an off-hook condition and receives the audio signals picked up by the pick up telephone. In this case analogue data are then converted to digital data. Also a digital path from the telephone can be used when available. The digital data are compressed and packed to be available to a listener through the Internet. A broadcasting means including hardware and software receives requests from listeners and broadcasts the information.

### BRIEF DESCRIPTION OF THE DRAWINGS

The invention will now be described in more detail with reference to specific embodiments thereof shown on the accompanying drawings.

FIG. 1 is a schematic view of a prior art system for broadcasting through the Internet.

FIG. 2 is a schematic view of one embodiment of a device in accordance with the invention.

FIG. 3 is a schematic circuit diagram of a part of the device in FIG. 2.

### DETAILED DESCRIPTION

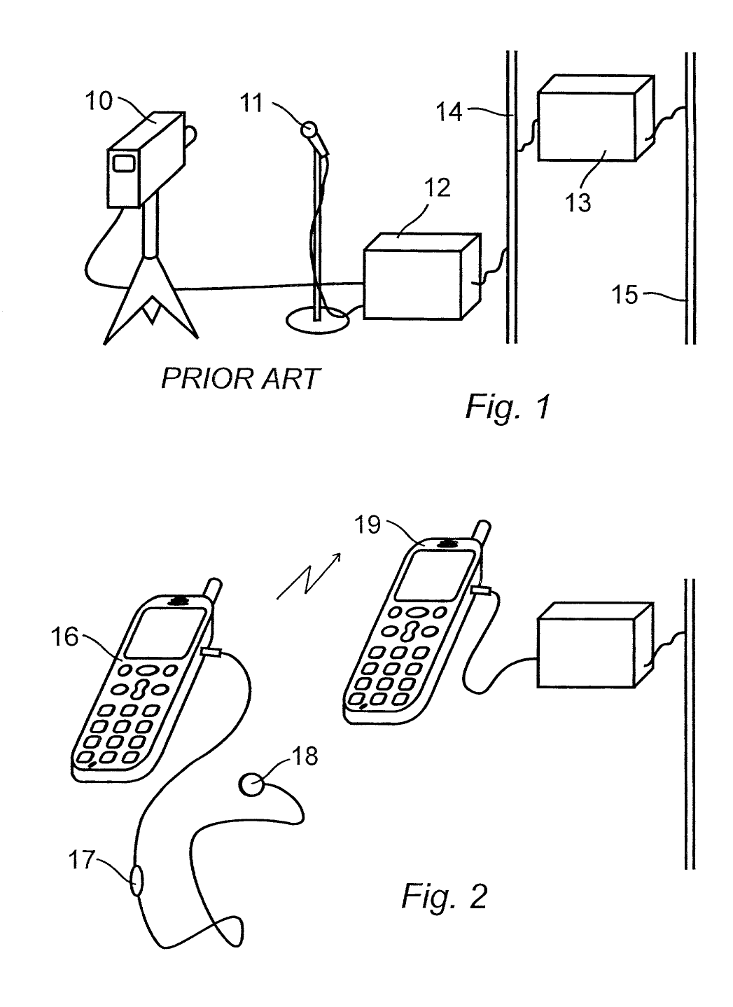

FIG. 1 shows some of the equipment used in a prior art system for broadcasting through the Internet. A television camera 10 and a microphone 11 are connected to a digitising and encoding computer 12. The system may very well include a plurality of cameras and microphones. The digitising and encoding computer 12 has to be monitored and handled by at least one person.

Signals from the camera 10 and the microphone 11 are digitised and encoded by the digitising and encoding computer 12, which is connected to a broadcasting computer 13 through an available first network 14. Normally, a short term rented ISDN line is used.

The broadcasting computer 13 is connected to a local or public second network 15 to make the information available at a web site. In many applications the second network is the Internet. It would also be possible to use the Internet in both instances. Any user that is connected to the Internet may access the web site where video and audio signals are available. Transmission can also be encrypted or restricted with regard to authorised users.

In the embodiment of the invention shown in FIG. 2 only sound signals are picked up. A conventional first cellular telephone 16 can be used as a pickup device. The reception of sound signals is improved by the use of a headset including a small pickup microphone 17. The headset may include also an earphone 18.

The sound signals picked up by the first cellular telephone 16 are transferred to a second cellular telephone 19. Also the second cellular telephone 19 may be a conventional telephone but may instead be a stripped phone with only some facilities. The GSM (Global System for Mobile communication) telephone system or a similar available system can be used. An advantage with cellular telephones is that the telephone number and subscription can be exchanged readily. It is possible also to use application specific devices for retrieving the sound signals and for transferring them in a suitable format. Instead of wireless phones also conventional wired telephones and a public phone network can be used.

When available also other systems than GSM can be used, such as the GPRS (General Packet Radio Service) or UMTS (Universal Mobile Telecommunication System). These systems are designed for a higher information transfer rate and will allow the transfer also of images and video. A video camera connected to or included in the cellular telephone is then used for retrieving video signals. The video signals are transferred to a second telephone or corresponding device as described above. Also other data such as data from white board digitizers, projector units and scanners can be transferred and made available as described above.

The second telephone is connected to computer means 20 having different functions. It is possible to use a conventional computer, such as a MACINTOSH G3, available from Apple Computer, Cupertino, Calif., US. The computer means 20 includes a digitising section performing an analogue to digital conversion of the analogue sound signal received by the second telephone 19. Where sound signals and other signals appear in digital form no conversion has to be performed. An example of a program suitable for such a conversion is SORENSON BROADCASTER available from Sorenson Media Inc. Salt Lake City, Utah, USA.

The computer means 20 also includes an encoding and packaging section that prepares the digital data to a streaming format. An example of an encoding program suitable for the encoding of audio is QUALCOMM PUREVOICE available from Qualcomm Inc., San Diego, Calif., USA. An example of a program suitable for the packaging task is QUICK TIME, available from Apple Computer, Cupertino, Calif., US.

Both the computer means 20 and the software used for digitising, packaging and broadcasting will operate also on video signals. Thus, both sound an vision will be available to network subscribers.

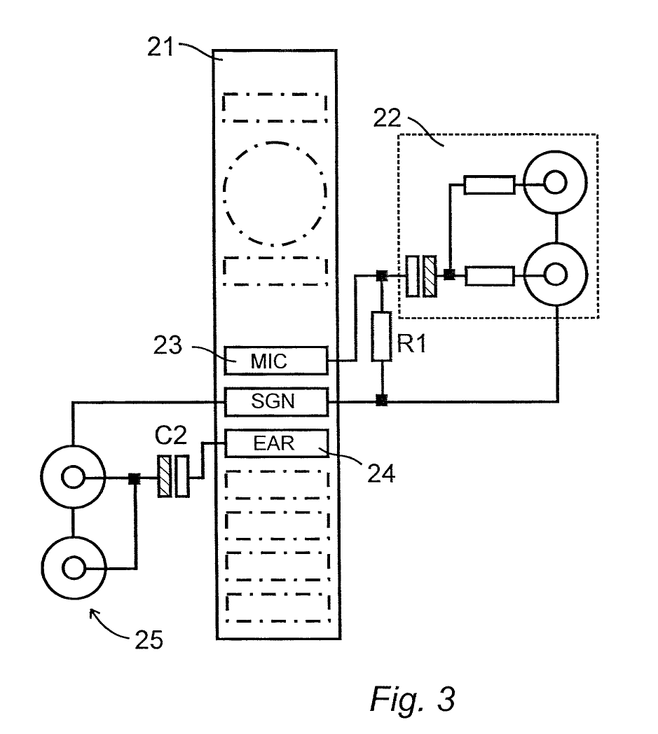

FIG. 3 shows a connector 21 of the second cellular telephone 19, such as a Nokia 61xx. The second cellular telephone 19 is put in an auto-answer mode, so as to answer automatically when a call is made from the first cellular telephone. The connector includes a plurality of terminals, some of which are not described here. A connecting means similar to a headset is connected to the connector 21.

The connecting means includes a circuitry 22 that can be used for retrieving sound signals. The circuitry 22 is not further described here, whereas sound signals in this direction is not used in this embodiment. However, a resistor R1 is used to bridge a microphone input terminal 23 of the connecting means. The value of the resistor is 4,7 kOhm.

An earphone output terminal 24 of the connecting means is connected to terminal means 25 through a capacitor C1. The capacitor C1 is used to block signals at a DC level and has the value 10 μF in this embodiment.

1. A method for communication over a network, such as the Internet, including the steps of retrieving at least audio signals, digitising the signals into digital signals if the signals are available in analogue form, transferring the digital signals to broadcasting means and making the digital signals accessible over a network, such as the Internet, characterised by retrieving at least audio signal in a mobile telecommunication device, and transferring at least audio signals from the mobile telecommunication device to a corresponding receiving telecommunication device over a wireless connection.

2. A method according to claim 1, including the step of transferring at least audio signals from the receiving telecommunication device to a combined digitising, packaging and broadcasting device that is connected to the Internet, a digitising unit required in the device when the at least audio signals are provided in analogue form.

3. A method according to claim 1, wherein the mobile telecommunication device is a cellular telephone.

4. A device for communication over a network, such as the Internet, including the steps of retrieving at least audio signals, digitising the signals into digital signals if the signals are available in analogue form, transferring the digital signals to broadcasting means and making the digital signals accessible over a network, such as the Internet, characterised in
that a mobile telecommunication device is used for retrieving at least audio signals,
that the mobile telecommunication device is connected in a wireless connection to a corresponding receiving telecommunication device, and
that the receiving telecommunication device is operatively connected to a to a combined digitising, packaging and broadcasting device that is connected to the Internet, a digitising unit required in the device when the at least audio signals are provided in analogue form.

5. A device according to claim 4, wherein the mobile telecommunication device is a cellular telephone.

6. A device according to claim 5, wherein the receiving telecommunication device is a cellular telephone.

7. A device according to claim 4, wherein the combined digitising, packaging and broadcasting device is a computer running programs for digitising, packaging and broadcasting, a digitising section required in the program when the at least audio signals are provided in analogue form.
